(19) United States
(12) Patent Application Publication
(10) Pub. No.: US 2026/0153233 A1
(43) Pub. Date: Jun. 4, 2026

(54) OUTGASSING FILTERING SYSTEM FOR A LUMINAIRE

(71) Applicant: ROBE lighting s.r.o., Roznov pod Radhostem (CZ)

(72) Inventors: Pavel Jurik, Prostredni Becva (CZ); Josef Valchar, Prostredni Becva (CZ)

(21) Appl. No.: 19/459,834

(22) Filed: Jan. 26, 2026

(51) Int. Cl. F21V 29/67; F21V 29/504; F21V 29/61; F21V 31/00

(52) U.S. Cl. CPC F21V 29/677; F21V 29/504; F21V 29/61; F21V 31/005; G02B 27/0006

(57) ABSTRACT

A luminaire is provided, that includes a head having a housing. The head includes a light source that generates heat; one or more motors that generate heat; one or more lubricated surfaces that, when heated, release airborne contaminants; one or more painted surfaces that, when heated, release airborne contaminants; a plurality of lenses; and an adsorptive filter system configured to reduce airborne contaminants in air contacting one or more lenses of the plurality of lenses by pulling contaminated air through the filter system and directing filtered air onto the plurality of lenses.

### TECHNICAL FIELD OF THE DISCLOSURE

The disclosure generally relates to luminaires, and more specifically to a system and method for removing contamination from the air in a closed compartment of a luminaire.

### BACKGROUND

Luminaires with automated and remotely controllable functionality (which may be referred to as automated luminaires) are well known in the entertainment and architectural lighting markets. Such products are commonly used in theatres, television studios, concerts, theme parks, night clubs, and other venues. A typical automated luminaire provides control from a remote location of the pan and tilt functions of the luminaire allowing an operator to control the direction the luminaire is pointing and thus the position of the light beam on the stage or in the studio. Many automated luminaires additionally or alternatively provide control from the remote location of other parameters such as intensity, focus, zoom, beam size, beam shape, and/or beam pattern of light beam(s) emitted from the luminaire. Some automated luminaire products may be designed for outdoors in, for example, theme parks or concerts. Such luminaires may be designed to maintain a dry, controlled physical environment inside the luminaire.

### BRIEF DESCRIPTION OF THE DRAWINGS

For a more complete understanding of this disclosure, reference is now made to the following brief description, taken in conjunction with the accompanying drawings in which like reference numerals indicate like features.

FIG. 1 presents an orthogonal view of a luminaire comprising an adsorptive filter system according to the disclosure;

FIG. 2 presents an orthogonal view of a head of the luminaire of FIG. 1 with a housing removed to show internal components of the head;

FIG. 3 presents an orthogonal view of the adsorptive filter system according to the disclosure; and

FIG. 4 presents an exploded view of a portion of the adsorptive filter system of FIG. 3.

### SUMMARY

In a first embodiment, a luminaire includes a head having a housing. The head includes a light source that generates heat; one or more motors that generate heat; one or more lubricated surfaces that, when heated, release airborne contaminants; one or more painted surfaces that, when heated, release airborne contaminants; a plurality of lenses; and an adsorptive filter system configured to reduce airborne contaminants in air contacting one or more lenses of the plurality of lenses by pulling contaminated air through the filter system and directing filtered air onto the plurality of lenses.

### DETAILED DESCRIPTION

Preferred embodiments are illustrated in the figures, like numerals being used to refer to like and corresponding parts of the various drawings.

Luminaires may contain materials which can outgas, particularly when heated. For example, plastics, adhesives, and paints may release airborne contaminants including VOCs (Volatile Organic Compounds) when they are heated. In addition, luminaires may contain electronics and circuit boards whose packaging and other materials outgas. Further, motors (such as stepper motors), bearings, linear slides, and other lubricated surfaces may also outgas. Heat from a light source in the luminaire may be a primary source of heat that may trigger outgassing. However, stepper motors also generate heat internally during normal operation, and may also be significant producers of contaminants, even when the light source itself is turned off.

Such outgassed airborne contaminants may re-condense or be otherwise deposited (for example, by contaminant particles contacting and attaching to a surface) on surfaces within the luminaire, including on lenses and/or other optical elements of the luminaire, through which a light beam generated by the light source passes before exiting the luminaire. Such condensation and/or deposition may gradually accumulate as a film coating on those components. Such a film may diffuse the light passing through the optical elements, possibly resulting in a hazy light output, which may have haloes around the emitted light beam. One remedy to such a problem may be for the user to open the luminaire and clean surfaces of the optical elements, in order to regain the original sharp light output. However, the hazy coating may reappear quickly as the luminaire is used and outgassing continues.

The problem is likely exacerbated with luminaires intended for outdoor use which may be sealed and water tight. In such products the outgassed contaminants have no route to exit the luminaire and end up condensing and/or depositing on internal surfaces.

Some systems may attempt to solve the problem of outgassing by using heaters and directed air flow to attempt to prevent outgassed contaminants from condensing on optical surfaces. However, such solutions only attempt to direct airborne contaminants away from optical elements and don't actually remove the contaminants from the air inside the luminaire. Furthermore, once such a luminaire is powered down, such heating and air flow may cease, allowing contaminants to condense and/or deposit on the optical elements.

Systems according to the disclosure reduce deposition of contaminants from the air inside the luminaire on optical elements of the luminaire by pulling contaminated air through an adsorptive filter system and directing the filtered air onto on lenses and/or other optical elements of the luminaire.

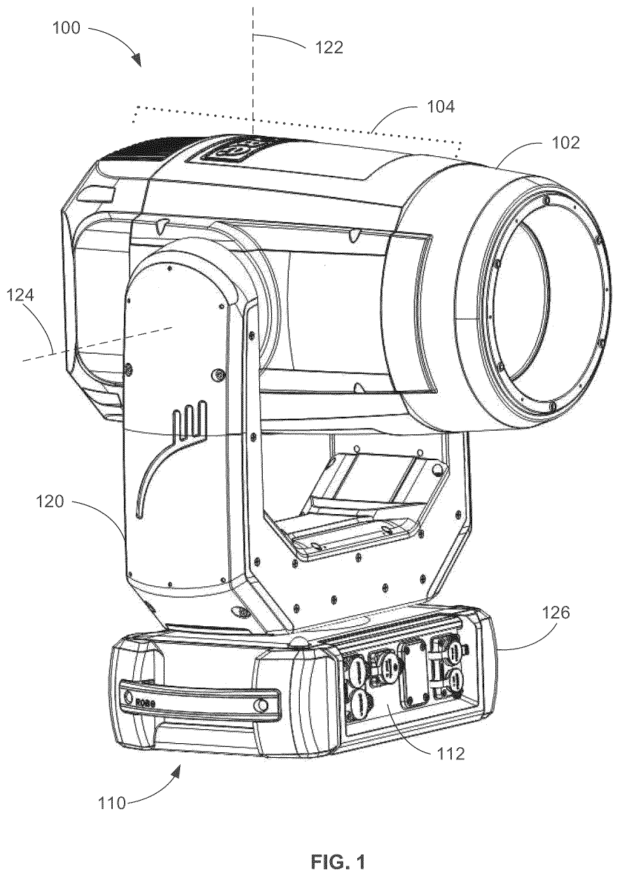

FIG. 1 presents an orthogonal view of a luminaire 100 comprising an outgassing filtering system according to the disclosure. The luminaire 100 is a luminaire comprising a head 102 which is configured to rotate within a yoke 120 about a tilt axis 124. The head 102 comprises a housing 104. In some embodiments, the housing 104 is configured to make the head 102 waterproof. The yoke 120 is configured to rotate relative to a fixed enclosure 126 about a pan axis 122. The pan axis 122 and the tilt axis 124 are orthogonal to each other. Both pan and tilt motions may be mechanically coupled to hand-operated manual controls or may be coupled for motion to motors, linear actuators, or other electromechanically controlled mechanisms.

Such electromechanical mechanisms and other components of the luminaire 100 may be under the control of a control system 110 (e.g., a microcontroller or other programmable processing system) included in the luminaire 100. In some embodiments, the control system 110 may communicate with a user and be controlled locally via a user interface 112 included in the luminaire 100. In such embodiments, the control system 110 may display information to the user on a display screen of the user interface 112. Such information may relate to a status of a component of the luminaire 100. In other embodiments, the control system 110 may be in wired or wireless communication via a data link with a remotely located control console that an operator uses to indicate a desired position of the head 102. In such embodiments, the operator is able to direct light output from the luminaire 100 in a desired direction, through motion of the head 102 in the pan axis 122 and tilt axis 124.

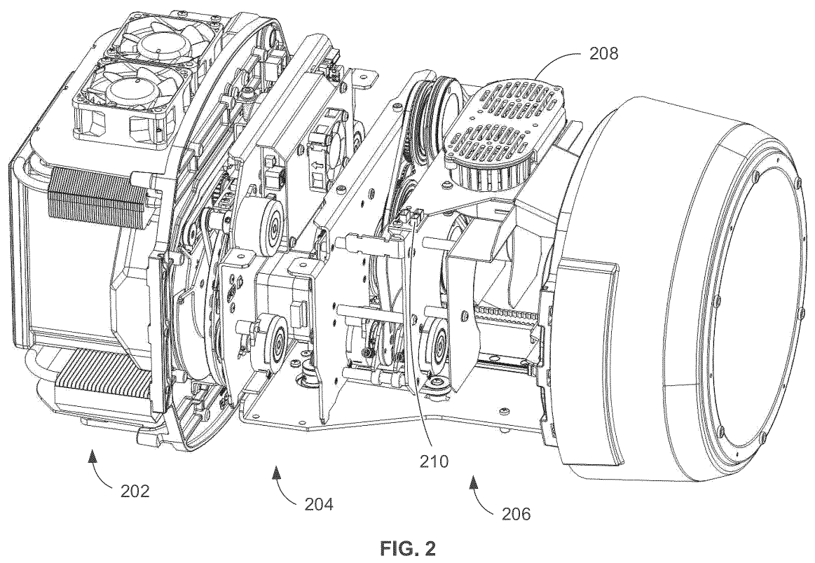

FIG. 2 presents an orthogonal view of the head 102 of the luminaire 100 of FIG. 1 with the housing 104 removed to show internal components of the head 102. In the orientation shown in FIG. 2, the left end of the head 102 may be referred to as the rear and the right end of the head 102 referred to as the front. The head 102 comprises a light source 202, optical components 204, and a zoom optical system comprising a plurality of lenses 206.

As described above, the internal components of the head 102 may comprise materials that can outgas, such as lubricants, plastics, adhesives, and paints that may release airborne contaminants including VOCs when heated. To reduce the amount of such airborne contaminants, the head 102 further comprises an adsorptive filter system 208, configured to reduce airborne contaminants in air that contacts one or more lenses of the plurality of lenses 206 by pulling contaminated air from rearward portions of the head 102 through the adsorptive filter system 208 and directing the resulting filtered air onto the plurality of lenses 206. The adsorptive filter system 208 is mounted in the luminaire 100 in a position that reduces the amount of contaminated air pulled across the plurality of lenses 206 into the adsorptive filter system 208. Baffles and bulkheads that are used to mount the adsorptive filter system 208 may also reduce the amount of contaminated air that is pulled across the plurality of lenses 206.

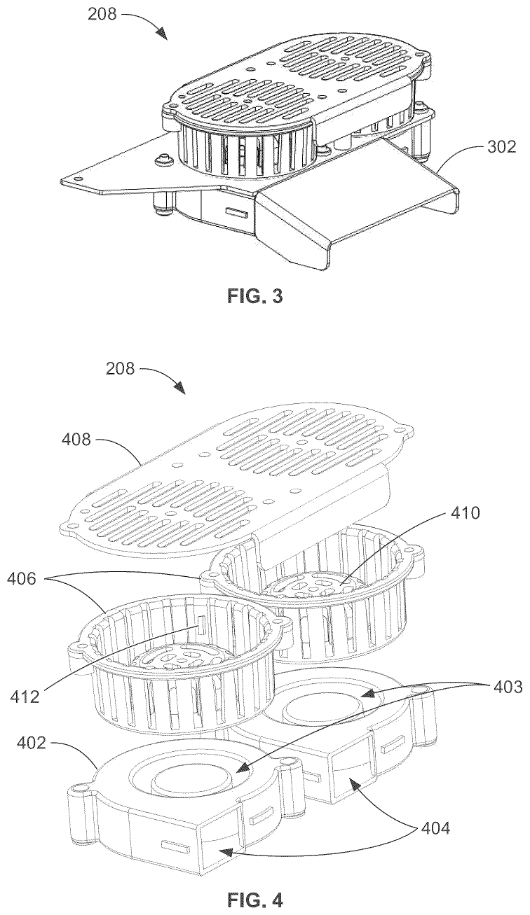

FIG. 3 presents an orthogonal view of the adsorptive filter system 208 according to the disclosure. As will be explained in more detail with reference to FIG. 4, a bottom portion of the adsorptive filter system 208 (as oriented in FIG. 3) comprises fans 402 that pull contaminated air through the adsorptive filter system 208 and expel filtered air. The adsorptive filter system 208 comprises a baffle 302 that deflects the filtered air expelled from the fans 402 onto the plurality of lenses 206.

Returning to FIG. 2, in some embodiments, the head 102 includes a sensor 210 configured to sense airborne contaminants within the housing and to produce a signal related to an amount of airborne contaminants sensed. In such embodiments, the sensor 210 is electrically coupled to the control system 110 and the control system 110 is configured to control a speed of fans 402 based on the signal produced by the sensor 210. In one example, the control system 110 causes the fans 402 to pull more air through the adsorptive filter system 208 when the signal produced by the sensor 210 indicates a higher amount of airborne contaminants in the housing.

FIG. 4 presents an exploded view of the adsorptive filter system 208 of FIG. 3. The adsorptive filter system 208 comprises two fans 402, two associated cup-shaped containers 406, and a cover 408. Each fan 402 comprises an air intake 403 and an air outlet 404. Each fan 402 is configured to pull air into its air intake 403 through its associated cup-shaped container 406 and the cover 408 and to expel air from its air outlet 404

Each cup-shaped container 406 is configured to contain activated charcoal pellets and has a cylindrical wall, an open first end at its top, and a closed second end at its bottom, in the orientation shown in FIG. 4. The activated charcoal pellets are not shown in FIG. 4 in order to more clearly show the structure of the cup-shaped containers 406. The closed second end comprises a protrusion 410 extending into an interior of the cup-shaped container 406. The closed second end of the cup-shaped container 406 is thus configured to couple to its associated fan 402. The protrusion 410 and the cylindrical wall comprise openings that are configured to allow passage of air and prevent passage of the activated charcoal pellets. The cover 408 also comprises openings that are configured to allow passage of air and prevent passage of the activated charcoal pellets. Each cup-shaped container 406 is thus configured to contain its activated charcoal pellets in an inverted cup shape, improving airflow between the cylindrical wall and the protrusion 410.

While the embodiment of FIGS. 3 and 4 comprises two fans 402 and two cup-shaped containers 406, other embodiments may comprise more or fewer than two fans 402 and two cup-shaped containers 406. Similarly, while the embodiment of FIGS. 3 and 4 comprises a single cover 408 for the two cup-shaped containers 406, other embodiments may comprise two covers 408, one for each of the two cup-shaped containers 406.

In some embodiments, one of the cup-shaped containers 406 includes a sensor 412 configured to sense a contaminant saturation of the activated charcoal pellets in the cup-shaped container 406 and to produce a signal related to an amount of contaminant saturation sensed in the activated charcoal pellets. In such embodiments, the sensor 412 is electrically coupled to the control system 110 and the control system 110 is configured to compare the signal to a threshold value and display on the user interface 112 information relating to a result of the comparison. In one example, if the signal is above the threshold value, the control system 110 displays information on the user interface 112 indicating that the activated charcoal pellets are excessively contaminated and require replacement.

While only some embodiments of the disclosure have been described herein, those skilled in the art, having benefit of this disclosure, will appreciate that other embodiments may be devised which do not depart from the scope of the disclosure herein. While the disclosure has been described in detail, it should be understood that various changes, substitutions, and alterations can be made hereto without departing from the spirit and scope of the disclosure.

What is claimed is:

1. A luminaire, comprising:
a head having a housing, the head comprising:
a light source that generates heat;
one or more motors that generate heat;
one or more lubricated surfaces that, when heated, release airborne contaminants;
one or more painted surfaces that, when heated, release airborne contaminants;
a plurality of lenses; and
an adsorptive filter system configured to reduce airborne contaminants in air contacting one or more lenses of the plurality of lenses by pulling contaminated air through the adsorptive filter system and directing filtered air onto the plurality of lenses.

2. The luminaire of claim 1, wherein the adsorptive filter system is mounted in the luminaire in a position that reduces an amount of contaminated air pulled across the plurality of lenses into the adsorptive filter system.

3. The luminaire of claim 1, wherein the housing is configured to make the head waterproof.

4. The luminaire of claim 1, further comprising:
a user interface;
a control system; and
a sensor configured to sense a contaminant saturation of the adsorptive filter system and to produce a signal related to an amount of contaminant saturation of the adsorptive filter system,
wherein the control system is electrically coupled to the sensor and the user interface and the control system is configured to:
compare the signal to a threshold value, and
display information relating to a result of the comparison on the user interface.

5. The luminaire of claim 1, wherein the adsorptive filter system comprises a fan configured to pull the contaminated air through the adsorptive filter system.

6. The luminaire of claim 5, wherein the adsorptive filter system comprises activated charcoal pellets.

7. The luminaire of claim 6, wherein:
the adsorptive filter system comprises a cup-shaped container configured to contain the activated charcoal pellets and having a cylindrical wall, an open first end, and a closed second end;
the closed second end comprises a protrusion extending into an interior of the cup-shaped container;
the protrusion and the cylindrical wall comprise first openings configured to allow passage of air and prevent passage of the activated charcoal pellets; and
the closed second end is configured to couple to the fan, such that air pulled into the fan through the protrusion passes through the activated charcoal pellets after passing through the open first end of the cup-shaped container and the first openings in the cylindrical wall.

8. The luminaire of claim 7, wherein the adsorptive filter system comprises a cover over the open first end of the cup-shaped container, the cover comprising second openings configured to allow passage of air and prevent passage of the activated charcoal pellets.

9. The luminaire of claim 5, further comprising:
a control system; and
a sensor configured to sense airborne contaminants within the housing and to produce a signal related to an amount of airborne contaminants sensed within the housing,
wherein the sensor is electrically coupled to the control system and the control system is configured to control a speed of the fan based on the signal produced by the sensor.
